(19) United States
(12) Patent Application Publication
(10) Pub. No.: US 2008/0129769 A1
(43) Pub. Date: Jun. 5, 2008

(54) METHOD OF DRIVING PIEZOELECTRIC INKJET PRINTHEAD AND IMAGE FORMING APPARATUS

(75) Inventor: Woo-sik KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/768,357

(22) Filed: Jun. 26, 2007

(30) Foreign Application Priority Data
Dec. 1, 2006 (KR) 2006-120957

(51) Int. Cl. B41J 29/38

(52) U.S. Cl. 347/10

(57) ABSTRACT

A method of driving a piezoelectric inkjet printhead, the method including: applying a forward voltage to a piezoelectric body of the piezoelectric actuator; and applying a driving pulse to the piezoelectric body based on the forward voltage as a reference voltage in order to eject ink. Accordingly, the piezoelectric body can be driven in a push mode and in a pull mode without applying a backward voltage to the piezoelectric body.

### CROSS-REFERENCE TO RELATED APPLICATIONS

This application claims the benefit of Korean Patent Application No. 10-2006-0120957, filed on Dec. 1, 2006 in the Korean Intellectual Property Office, the disclosure of which is incorporated herein in its entirety by reference.

### BACKGROUND OF THE INVENTION

1. Field of the Invention

The present general inventive concept relates to a method of driving an inkjet printhead that ejects ink in a piezoelectric mode, and more particularly, to a method of driving a piezoelectric inkjet printhead using a piezoelectric actuator including a piezoelectric body with a sintered piezoelectric material, and an image forming apparatus that drives an inkjet printhead that ejects ink in a piezoelectric mode.

2. Description of the Related Art

Inkjet printheads are apparatuses that eject minute droplets of printing ink on desired positions of a recording medium in order to print predetermined color images. Inkjet printers include inkjet printheads for ejecting ink, and inkjet printheads are categorized into two types according to the ink ejection mechanism thereof. The first type is a thermal inkjet printhead that ejects ink due to an expansion force of bubbles generated in the ink by thermal energy. The other type is a piezoelectric inkjet printhead that ejects ink droplets by a pressure applied to the ink due to the deformation of a piezoelectric body of the piezoelectric inkjet printhead.

As illustrated in FIG. 1, when a voltage in a forward direction is applied to the piezoelectric body 10 of a piezoelectric actuator, the piezoelectric body 10 extends in the poling direction, and when a voltage in a backward direction is applied, the piezoelectric body 10 shrinks in the poling direction. The voltage in a forward direction refers to a voltage applied in the poling direction of the piezoelectric body 10, and the voltage in a backward direction refers to a voltage applied in the opposite direction of the poling direction of the piezoelectric body 10. When a diaphragm 20 is formed below the piezoelectric body 10 in FIG. 1, and a voltage in a forward direction is applied to the piezoelectric body 10, the diaphragm 20 bends in a downward direction and thus a push mode is set, and when a backward voltage is applied to the piezoelectric body 10, the diaphragm 20 bends in an upward direction and thus a pull mode is set.

Conventionally, when a high voltage is applied in a backward direction to the piezoelectric body 10, the poling of the piezoelectric body is released and the piezoelectric body does not operate anymore. In the case of a bulk piezoelectric body that is attached to the diaphragm 20 of an inkjet printhead, the critical voltage at which poling is released is high, and thus the bulk piezoelectric body may be used to some degree in a pull mode. However, when the piezoelectric body 10 is formed by coating a piezoelectric material in a paste form on the diaphragm 20 and then sintering the piezoelectric material of the piezoelectric body 10 when manufacturing an inkjet printhead, the critical voltage at which the poling is released is low, and thus the piezoelectric body 10 can hardly operate in a pull mode. Due to such a limitation of the backward voltage, in a conventional piezoelectric inkjet printhead, as illustrated in FIG. 2, a driving pulse 30 having a reference voltage of 0 V is applied to the piezoelectric body 10 to operate in a push mode.

### SUMMARY OF THE INVENTION

The present general inventive concept provides a method of driving a piezoelectric inkjet printhead that can be driven in a push mode and a pull mode without applying a backward voltage to a piezoelectric body.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of driving a piezoelectric inkjet printhead including a pressure chamber connected in line with a nozzle and a piezoelectric actuator providing a driving force for ejecting ink from the pressure chamber, the method including applying a forward voltage to a piezoelectric body of the piezoelectric actuator, and applying a driving pulse to the piezoelectric body based on the forward voltage as a reference voltage in order to eject ink.

The forward voltage may be gradually increased up to the reference voltage such that ink is not ejected.

The foregoing and/or other aspects and utilities of the present general inventive concept may also be achieved by providing a method of driving a piezoelectric inkjet printhead including a pressure chamber connected in line with a nozzle and a piezoelectric actuator providing a driving force for ejecting ink to the pressure chamber, the method including converting a piezoelectric body of the piezoelectric actuator to a push mode at a speed such that ink is not ejected, and ejecting ink by applying a driving pulse, which sequentially converts the piezoelectric body into a pull mode and the push mode, to the piezoelectric body.

The converting of the piezoelectric body into a push mode may include applying a forward voltage, which is gradually increased such that ink is not ejected, to the piezoelectric body, and when the forward voltage reaches the reference voltage, maintaining the reference voltage.

The foregoing and/or other aspects and utilities of the present general inventive concept may also be achieved by providing an image forming apparatus usable with a piezoelectric inkjet printhead, including a controller to generate a first signal to convert the piezoelectric printhead to a push mode at a speed such that ink is not ejected and to generate a second signal to convert the piezoelectric body into a pull mode and then to the push mode to eject ink therefrom.

The first signal causes a pulse applying unit of the piezoelectric printhead to apply a first driving pulse to a piezoelectric actuator of the printhead, and the second signal causes the pulse applying unit of the piezoelectric printhead to apply a second driving pulse to a piezoelectric actuator of the printhead.

The foregoing and/or other aspects and utilities of the present general inventive concept may also be achieved by providing a method of driving a piezoelectric inkjet printhead including a pressure chamber connected in line with a nozzle and a piezoelectric actuator providing a driving force to eject ink to the pressure chamber by an image forming apparatus, the method including generating a first signal to convert a piezoelectric body of the piezoelectric actuator to a push mode at a speed such that ink is not ejected, and generating a second signal to convert the piezoelectric body into a pull mode and the push mode to eject ink therefrom.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates the movement of a piezoelectric body by a forward voltage and a backward voltage;

FIG. 2 illustrates a driving pulse applied in a conventional driving method of a piezoelectric inkjet printhead;

FIG. 3 is a cross-sectional view of a piezoelectric inkjet printhead to which a driving method of a piezoelectric inkjet printhead is applied, according to an embodiment of the present general inventive concept;

FIG. 4 illustrates a driving pulse applied in a driving method of a piezoelectric inkjet printhead, according to an embodiment of the present general inventive concept;

FIG. 5 illustrates a push mode of a piezoelectric layer, according to an embodiment of the present general inventive concept;

FIG. 6 illustrates another driving pulse applied in a driving method of a piezoelectric inkjet printhead, according to an embodiment of the present general inventive concept;

FIG. 7 illustrates another driving pulse applied in a driving method of a piezoelectric inkjet printhead, according to an embodiment of the present general inventive concept;

FIG. 8 illustrates time intervals between a falling section and a rising section of the driving pulse applied in a driving method of a piezoelectric inkjet printhead, according to an embodiment of the present general inventive concept;

FIG. 9 illustrates an image forming apparatus comprising a controller to control the piezoelectric actuator of FIG. 3, according to an embodiment of the present general inventive concept; and

FIG. 10 illustrates a method of controlling the piezoelectric actuator of FIG. 3 by the controller of the image forming apparatus of FIG. 9, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

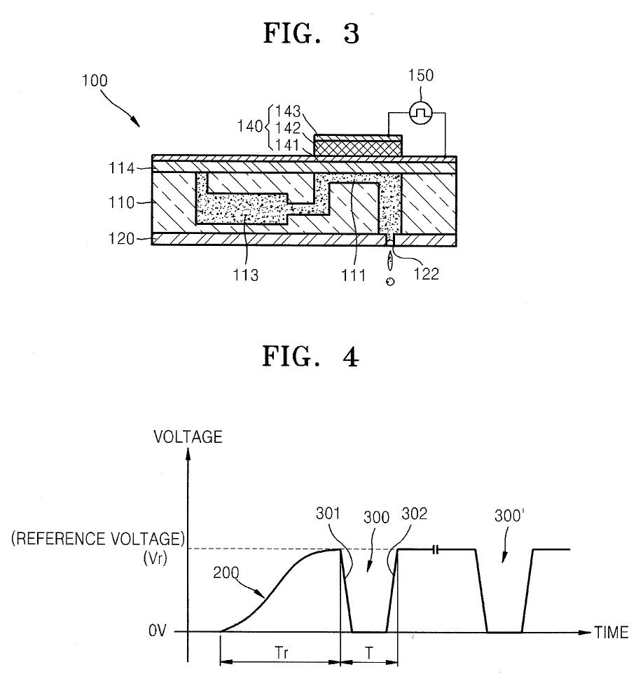

FIG. 3 is a cross-sectional view of a piezoelectric inkjet printhead 100 to which a driving method of a piezoelectric inkjet printhead 100 is applied, according to an embodiment of the present general inventive concept.

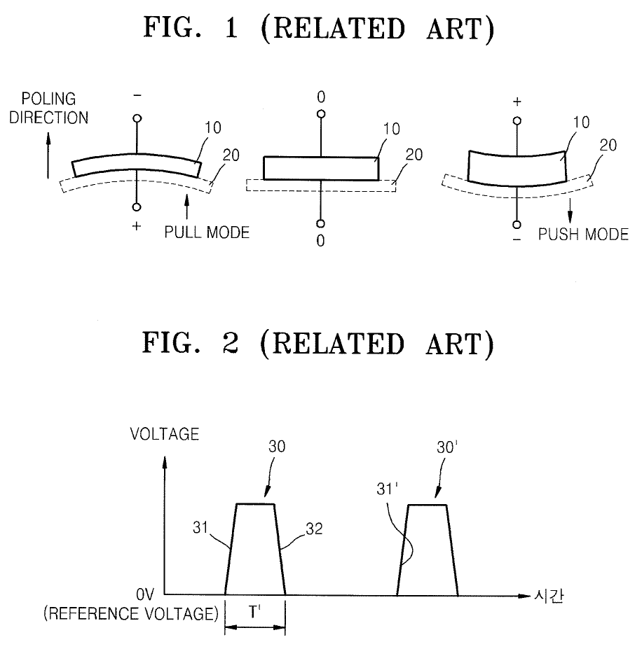

Referring to FIG. 3, the piezoelectric inkjet printhead 100 includes a substrate 110 in which an ink passage is formed, and a piezoelectric actuator 140 to provide ink ejection pressure. The substrate 110 includes a pressure chamber 111 and a manifold 113 to supply ink to the pressure chamber 111. A nozzle substrate 120, in which a nozzle 122 connected in line with the pressure chamber 111 is formed, is bonded to the substrate 110 in which the ink passage is formed. A diaphragm 114 is vibrated by a piezoelectric actuator 140, and the diaphragm 114 forms a wall of the pressure chamber 111 in the current embodiment of FIG. 1.

The piezoelectric actuator 140 vibrates the diaphragm 114 to provide a driving force to the pressure chamber 111 to eject ink. The piezoelectric actuator 140 includes a common electrode 141, a piezoelectric layer 142 that is deformed according to the application of a voltage, and a driving electrode 143 to which a driving voltage is applied.

If the substrate 110 is formed of a silicon wafer, an insulating layer (not illustrated) is formed between the piezoelectric actuator 140 and the substrate 110. The insulating layer may be, for example, a silicon oxide layer formed using a plasma chemical vapor deposition (PECVD) method on the substrate 110.

The piezoelectric layer 142 can be formed by coating a piezoelectric material in a paste form on the insulating layer to a predetermined thickness, and then, sintering the coated piezoelectric material. The piezoelectric layer 142 is formed to correspond to the pressure chamber 111. Various piezoelectric materials can be used for the piezoelectric layer 142, such as, for example, lead zirconate titanate (PZT) ceramic may be used.

The common electrode 141 and the driving electrode 143 are formed of a conductive metal, and the common electrode 141 and the driving electrode 143 may be formed of one metal layer or two metal layers, such as a Ti layer and a Pt layer. The common electrode 141 and the driving electrode 143 may respectively be formed by depositing Ti and Pt on the surface of the insulating layer and the piezoelectric layer 142 to a predetermined thickness using a sputtering method. Also, the common electrode 141 and the driving electrode 143 may be formed of a conductive metal on the insulating layer and the piezoelectric layer 142, for example, by screen-printing Ag—Pd paste. If the common electrode 141 and the driving electrode 143 are formed by screen-printing Ag—Pd paste, the piezoelectric layer 142, the common electrode 141, and the driving electrode 143 are sintered at a predetermined temperature, for example, in the range of 900 to 1000° C. Afterwards, a poling process is performed by applying an electric field to the piezoelectric layer 142 in order to generate piezoelectric characteristics of the piezoelectric layer 142, and the piezoelectric layer 142 can be also formed by attaching a bulk piezolelectric material on the insulating layer.

A pulse applying unit 150 is utilized to apply a driving pulse to the driving electrode 143. According to an embodiment of the present general inventive concept, the piezoelectric inkjet printhead 300 is driven by applying a driving pulse to the piezoelectric layer 142 based on a forward voltage having a predetermined value that is not 0 V as a reference voltage Vr. The reference voltage Vr is a forward voltage, that is, a voltage in a poling direction of the piezoelectric layer 142. In other words, ink is ejected by setting the piezoelectric layer 142 into a push mode at an initial stage, and then, setting the piezoelectric layer 142 into a pull mode and a push mode by applying a driving pulse to the piezoelectric layer 142. A pull mode according to this embodiment refers to a state in which a displacement of the piezoelectric layer 142 is converted from a push mode to an initial state or to an arbitrary state between an initial mode and a push mode, and is distinguished from the pull mode described with reference to FIG. 1. Hereinafter, a driving method of the piezoelectric inkjet printhead according to the current embodiment will be described in more detail with reference to FIG. 4.

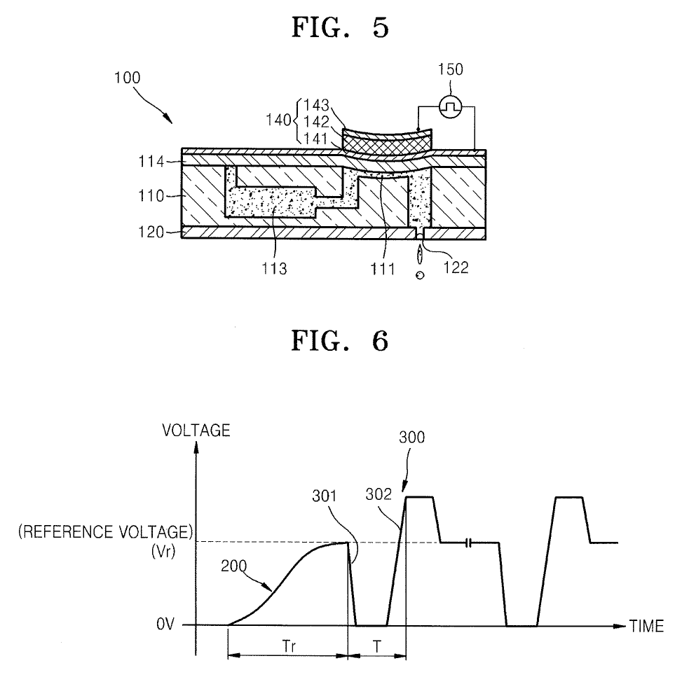

When the reference voltage Vr is applied to the piezoelectric layer 142 by the pulse applying unit 150, the piezoelectric layer 142 is in a push mode as illustrated in FIG. 5. In the present embodiment, when the reference voltage Vr is abruptly applied to the piezoelectric layer 142, ink can be ejected through the nozzle 122. Accordingly, as indicated by reference numeral 200 in FIG. 4, a forward voltage that is applied to the piezoelectric layer 142 is gradually increased from 0 V to the reference voltage Vr. Then, the piezoelectric layer 142 is converted from an initial mode illustrated in FIG. 3 to a push mode as illustrated in FIG. 5. The mode converting speed of the piezoelectric layer 142 in the initial stage is slow enough to prevent ink ejection. The actual time T that a driving pulse 300 is applied is 10 to 20 μs. Ink is ejected only when the displacement of the piezoelectric layer 142 is changed in such a short time of 10 to 20 μs. Accordingly, when a time Tr to convert from an initial mode to a push mode is set sufficiently longer than the actual time T, the driving pulse 300 is applied. For example, the time Tr is set for 1 second, and the piezoelectric layer 142 can be converted to a push mode under a condition where ink is not ejected from the nozzle 122. In the present embodiment, the time Tr, for to convert from an initial mode to a push mode, is set to 1 second, however, this is merely an example, and a shorter time is also possible as long as ink is not ejected from the nozzle 122.

Then, the driving pulse 300 is applied to print. The driving pulse 300 converts the piezoelectric layer 142 from a push mode to a pull mode, and then again to a push mode. That is, when the voltage applied to the piezoelectric layer 142 is decreased by a falling section 301 of the driving pulse 300, the piezoelectric layer 142 is converted from a push mode as illustrated in FIG. 5 to an initial mode illustrated in FIG. 3. The piezoelectric layer 142 bends upwardly and thus increasing the volume of the pressure chamber 111, and as such, the piezoelectric layer 142 is in a pull mode substantially. Then, when a voltage that is applied to the piezoelectric layer 142 is increased to a reference voltage Vr by a rising section 302 of the driving pulse 300, the piezoelectric layer 142 is converted to a push mode as illustrated in FIG. 5. Thus, as the volume of the pressure chamber 111 is reduced, ink is ejected through the nozzle 122. The piezoelectric layer 142 is maintained at the reference voltage Vr applied after the driving pulse 300 is applied until another driving pulse 300′ is applied to the piezoelectric layer 142.

As described above, the piezoelectric layer 142 can be driven in a push mode and a pull mode without having to apply a backward voltage to the piezoelectric layer 142 by applying the driving pulse 300 based on the reference voltage Vr. Hence, the piezoelectric layer 142 can be driven in a push mode and in a pull mode when a maximum voltage and a minimum voltage of the driving pulse 300 are in a forward direction with respect to the poling direction of the piezoelectric layer 142. Accordingly, regardless of a critical voltage at which the poling of the piezoelectric layer 142 is released, the piezoelectric layer 142 can be driven in a push mode and in a pull mode. Obviously, if the minimum voltage of the driving pulse 300 is sufficiently lower than a critical voltage in a backward direction at which the poling is released, the minimum voltage of the driving pulse 300 may be a backward voltage to some degree.

Ejection pressure formed in the pressure chamber 111 by the piezoelectric layer 142 depends on the effective displacement of the piezoelectric layer 142, and the effective displacement of the piezoelectric layer 142 depends on the difference between the maximum voltage and the minimum voltage of the driving pulse 300. Accordingly, as illustrated in FIG. 6, the maximum voltage of the driving pulse 300 may be higher than the reference voltage Vr.

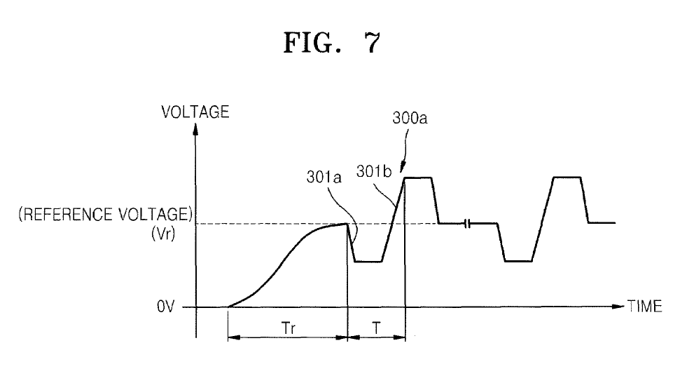

Also, when necessary, a driving pulse 300a, as illustrated in FIG. 7, may be applied to the piezoelectric layer 142. In this case, the piezoelectric layer 142 is converted from a push mode illustrated in FIG. 5 to an initial mode illustrated in FIG. 3 by a falling section 301a of the driving pulse 300a and then is converted again to a push mode by a rising section 302a, and then, ink is ejected through the nozzle 122. The falling section 301a of the driving pulse 300a corresponds to a pull mode.

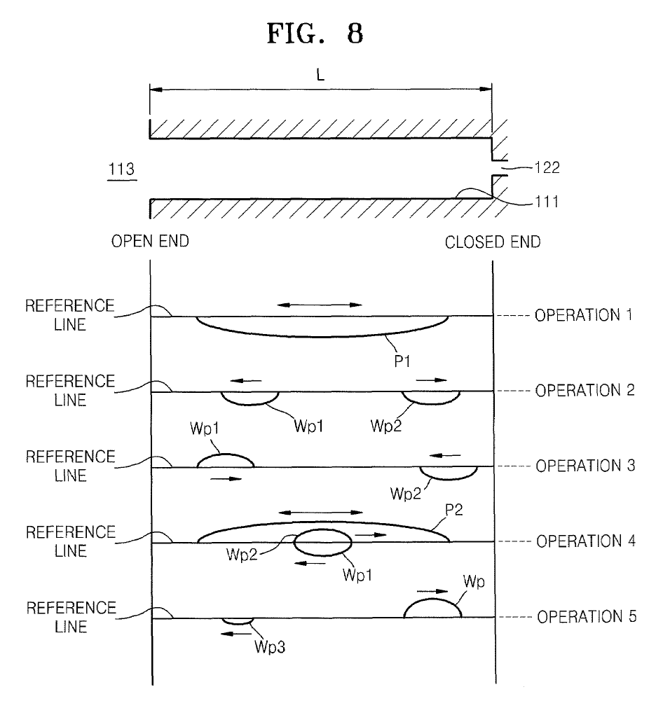

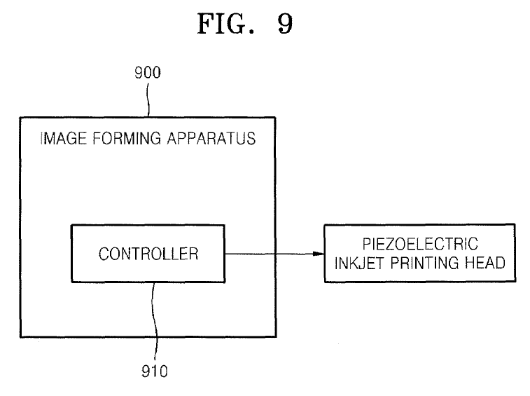

As described above, since the piezoelectric layer 142 can be driven in a pull mode and in a push mode, the following significant effects can be obtained. Referring to FIG. 8, the pressure chamber 111 may be modeled as a chamber having an effective length L, and of which an end is connected to the manifold 113 and another end is connected to the nozzle 122. The end connected to the manifold 113 can be seen as an open end and the end connected to the nozzle 122 can be seen as a closed end.

When the reference voltage Vr is applied to the piezoelectric layer 142, the piezoelectric layer 142 is maintained in a push mode. Then, the piezoelectric layer 142 is converted from a push mode to an initial mode by the falling section 301 of the driving pulse 300, and thus, substantially, the piezoelectric layer 142 is operated in a pull mode. Then, a pressure P1 is applied to the pressure chamber 111 (operation 1). The pressure P1 is illustrated with respect to and below a reference line to denote that the pressure P1 is a negative pressure. Thus, pressure waves Wp1 and Wp2 proceeding in opposite directions to each other are formed in the pressure chamber 111 (operation 2). The pressure wave Wp1 incident on the open end is reflected with its phase reversed, and the wave pressure Wp2 incident on the closed end is reflected without a change in its phase (operation 3). As the two reflected pressure waves Wp1 and Wp2 cross each other, the piezoelectric layer 142 is converted to a push mode again by a rising section 302 of the driving pulse 300, and thus, a positive pressure P2 is generated in the pressure chamber 111 (operation 4). The pressure wave Wp1 is offset by a positive pressure wave generated in the pressure chamber 111 by the positive pressure P2 and is changed to a pressure wave Wp3 having a small amplitude. Also, the pressure wave Wp2 generates an ejection pressure wave Wp by amplifying the positive pressure wave generated in the pressure chamber by the positive pressure P2 (operation 5).

If the piezoelectric layer 142 is converted to a push mode by the rising section 302 of the driving pulse 300 in operation 3, the positive pressure wave generated in the pressure chamber 111 by the pressure P2 cannot obtain the amplification effects by the pressure wave Wp1 having the same phase, and the size of the positive pressure wave is reduced by the pressure wave Wp2 having a different phase than the positive pressure wave. The time the piezoelectric layer 142 is converted to a push mode by the rising section 302 of the driving pulse 300 can be controlled by changing the time interval T between the falling section 301 and the rising section 302 of the driving pulse 300. Thus, the pressure loss of the ejection pressure wave Wp can be minimized by controlling the time interval T between the falling section 301 and the rising section 302 of the driving pulse 300 to convert the piezoelectric layer 142 to a push mode at the moment when the pressure waves Wp1 and Wp2 cross each other. For example, when a transmission speed of a pressure wave in ink, that is, the velocity of sound is C and the effective length of the pressure chamber 111 is L, and a pressure P1 is generated by a pull mode and a time L/C has elapsed, the pressure waves Wp1 and Wp2 cross each other. Accordingly, the time interval T between the falling section 301 and the rising section 302 of the driving pulse 300 can be set as nL/C (where n is a positive integer).

On the other hand, according to the conventional driving method of only operating in a push mode illustrated in FIG. 2, the driving pulse 30 starts from a rising section 31 and ends at a falling section 32. That is, the piezoelectric layer 142 is in a push mode by the rising section 31 and thus ink is ejected, and a time interval T′ between the rising section 31 and the falling section 32 merely maintains the piezoelectric layer 142 in a push mode during the time interval T′ and is different from the time interval T of the driving method of the present general inventive concept. Also, substantially, the time interval between the falling section 32 of a first driving pulse 30 and the rising section 31′ of the second driving pulse 30′ is related to a pixel interval of printing information and cannot be controlled to minimize the pressure loss of the ejecting pressure wave.

FIG. 9 illustrates an image forming apparatus 900 comprising a controller 910 to control the piezoelectric actuator 140. For example, the driving voltage can be controlled from the controller 910 of the image forming apparatus 900 according to an embodiment of the present general inventive concept, as illustrated in FIG. 9. Accordingly, when the piezoelectric inkjet printhead 100 is associated with the image forming apparatus 900, the controller 910 controls ejection of ink therefrom by providing predetermined signals to the pulse applying unit 150 of the piezoelectric actuator 140.

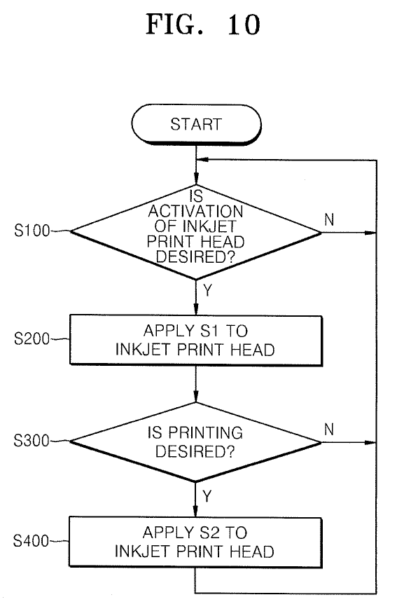

FIG. 10 illustrates a method of controlling the piezoelectric actuator 140 of the piezoelectric inkjet printhead 100 by the controller 910 of the image forming apparatus 900, according to an embodiment of the present general inventive concept. According to the method of FIG. 10, when printing is determined to be desired (operation S100), the controller 910 sends a first signal S1 to the pulse applying unit 150 of the of piezoelectric actuator 140 to convert the piezoelectric layer 142 from the initial mode to a push mode (operation S200). Thus, as a result of signal S1, a forward voltage 200 is applied to the piezoelectric layer 142 which gradually increases from 0V to the reference voltage Vr. The mode converting speed of the piezoelectric layer 142 in the initial stage is slow enough to prevent ink ejection. Then when printing is determined to be desired (operation S300), the controller 910 provides a second signal S2 to the pulse applying unit 150 of the piezoelectric actuator 140 to convert the piezoelectric layer 142 from a push mode to a pull mode, and then again to a push mode (operation S400). That is, the second signal S2 causes the voltage applied to the piezoelectric layer 142 to decrease by a falling section 301 of the driving pulse 300, converting the piezoelectric layer 142 to an initial mode, as illustrated in FIG. 3, and then subsequently causes the voltage applied to the piezoelectric layer 142 to increase to the reference voltage Vr by a rising section 302 of the driving pulse 300, converting the piezoelectric layer 142 to a push mode as illustrated in FIG. 5.

As described above, according to the driving method of the piezoelectric inkjet printhead according to the present general inventive concept, the time to generate ejection pressure can be controlled to minimize the pressure loss, and thereby, realizing stable printing quality.

As described above, according to the driving method of the piezoelectric inkjet printhead according to the present general inventive concept, the following effects can be obtained.

First, a piezoelectric body can be used in a push mode and in a pull mode without applying a backward voltage by applying a driving pulse based on a reference voltage having a predetermined value in a forward direction.

Second, the time to generate ejection pressure can be controlled to minimize pressure loss, and thereby, realizing stable printing quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of driving a piezoelectric inkjet printhead including a pressure chamber connected in line with a nozzle and a piezoelectric actuator providing a driving force to eject ink from the pressure chamber, the method comprising:
applying a forward voltage to a piezoelectric body of the piezoelectric actuator; and
applying a driving pulse to the piezoelectric body based on the forward voltage as a reference voltage in order to eject ink.

2. The method of claim 1, wherein a maximum voltage and a minimum voltage of the driving pulse are in a forward direction to the poling direction of the piezoelectric body.

3. The method of claim 1, wherein the forward voltage is gradually increased up to the reference voltage such that ink is not ejected.

4. The method of claim 2, wherein the maximum voltage and the minimum voltage of the driving pulse are in a forward direction to the poling direction of the piezoelectric body.

5. A method of driving a piezoelectric inkjet printhead including a pressure chamber connected in line with a nozzle and a piezoelectric actuator providing a driving force to eject ink to the pressure chamber, the method comprising:
converting a piezoelectric body of the piezoelectric actuator to a push mode at a speed such that ink is not ejected; and
ejecting ink by applying a driving pulse, which sequentially converts the piezoelectric body into a pull mode and the push mode, to the piezoelectric body.

6. The method of claim 5, wherein a maximum voltage and a minimum voltage of the driving pulse are in a forward direction to the poling direction of the piezoelectric body.

7. The method of claim 5, wherein the converting of the piezoelectric body into a push mode comprises: applying a forward voltage, which is gradually increased such that ink is not ejected, to the piezoelectric body; and when the forward voltage reaches the reference voltage, maintaining the reference voltage.

8. The method of claim 7, wherein the maximum voltage and the minimum voltage of the driving pulse are in a forward direction to the poling direction of the piezoelectric body.

9. An image forming apparatus usable with a piezoelectric inkjet printhead, comprising:
a controller to generate a first signal to convert the piezoelectric printhead to a push mode at a speed such that ink is not ejected and to generate a second signal to convert the piezoelectric body into a pull mode and then to the push mode to eject ink therefrom.

10. The image forming apparatus of claim 9, wherein the first signal causes a pulse applying unit of the piezoelectric printhead to apply a first driving pulse to a piezoelectric actuator of the printhead, and the second signal causes the pulse applying unit of the piezoelectric printhead to apply a second driving pulse to a piezoelectric actuator of the printhead.

11. A method of driving a piezoelectric inkjet printhead including a pressure chamber connected in line with a nozzle and a piezoelectric actuator providing a driving force to eject ink to the pressure chamber by an image forming apparatus, the method comprising:
generating a first signal to convert a piezoelectric body of the piezoelectric actuator to a push mode at a speed such that ink is not ejected; and
generating a second signal to convert the piezoelectric body into a pull mode and the push mode to eject ink therefrom.
